(19) United States
(12) Patent Application Publication
(10) Pub. No.: US 2006/0277171 A1
(43) Pub. Date: Dec. 7, 2006

(54) Custom media search tool

(76) Inventors: Steven Ellis, Tivoli, NY (US); Steven Askew, Germantown, NY (US)

Correspondence Address: PATENT DEPARTMENT;SKADDEN, ARPS, SLATE, MEAGHER & FLOM LLP, FOUR TIMES SQUARE, NEW YORK, NY, 10036, US

(21) Appl. No.: 11/497,192

(22) Filed: Aug. 1, 2006

Related U.S. Application Data
(63) Continuation of application No. 10/403,399, filed on Mar. 31, 2003.

(51) Int. Cl. G06F 17/30

(52) U.S. Cl. 707/3

(57) ABSTRACT

A search tool allows for convenient searching by employing unconventional search terms. The terms are from descriptor files, which are preferably provided by the multimedia content supplier who is familiar with the content. A user constructs a search query by selecting terms from groups of terms in categories. The user controls the search tool to display terms from various categories. The search results are displayed, along with the unconventional search terms to provide enhanced information relating to the retrieved content. The search tool further allows for the efficient export of cue sheet information for audio tracks.

### FIELD OF THE INVENTION

The present invention relates to computer software, and more specifically, to a search tool for retrieving digital multimedia content.

### BACKGROUND

Multimedia content is employed by individuals and professionals for various purposes. For example, individuals add music to home videos or create a music compilation from a personal music library by employing multimedia content. Professionals employ audio content as part of a video soundtrack or a television advertisement. Hence, both professionals and individuals require retrieval and preview of desired multimedia content as applicable to the corresponding tasks. Present search tools allow users to search for content according to commonly used descriptors such as title, type, and size. However, at times, common terms are not sufficiently descriptive to provide an efficient search without a manual review of content, especially with professionals who have access to a vast library of content. Furthermore, present search tools do not offer a convenient interface for tracking search terms employed in a search or modifying those terms. Therefore, there is a need for a search tool which allows users to search for multimedia content in accordance with additional descriptors and allows for convenient tracking and modifying of search terms employed in a search.

### SUMMARY

In accordance with an embodiment of the invention, a search tool is provided which allows for convenient searching by employing unconventional search terms. The terms are from descriptor files, which are preferably provided by the multimedia content supplier who is familiar with the content. A user constructs a search query by selecting terms from groups of terms in categories. The user controls the search tool to display terms from various categories. Regardless of the displayed category, the search terms are displayed in search term boxes, each associated with a category. Search results are provided in a results window. The search terms from the query can be modified by a selection of a corresponding search category box from the search term boxes.

In one embodiment, the invention provides a method for searching for content from a content database. The method provides a content database storing a plurality of content items, where each content item is stored in an identified location. The method also provides a plurality of search term files, each search term file associated with a search term category. Each search term file stores a plurality of pointers to the identified locations in the content database and a corresponding search term for each pointer. The method receives a plurality of search terms in a query. The method searches for pointers that are associated with search terms from the query in a first search term file to provide a first set of pointers. The method searches for pointers that are associated with search terms from the query and that are also included in the first set of pointers, in at least a second search term file. Finally, the method provides content identifiers, as result content, for content associated with the pointers from at least the second search term file.

In another embodiment, the invention provides a search engine screen for searching for multimedia content. The screen includes a terms display window, search term boxes, each associated with a search category, a Search button for facilitating the submission of a search query, a Clear Genre button for removing search terms of the genre currently associated with the terms display window, and a Clear All button for removing search terms of any category from a constructed query.

### BRIEF DESCRIPTION OF THE DRAWINGS

FIG. 1 illustrates a logical arrangement of modules of a search tool in accordance with the invention;

FIG. 2 illustrates a New Search screen of a search tool of the invention;

FIG. 3 illustrates a Results screen of a search tool of the invention;

FIG. 4 illustrates a Favorites screen of a search tool of the invention;

FIG. 5 illustrates a Cue Sheet Export screen of a search tool of the invention;

FIG. 6 illustrates a Moods term listing of the New Search screen;

FIG. 7 illustrates a Tempos term listing of the New Search screen;

FIG. 8 illustrates an Instruments term listing of the New Search screen;

FIG. 9 illustrates the Results screen of FIG. 2 in an expanded detail mode;

FIG. 10 illustrates the Results screen of FIG. 2, when displaying track information in the information window;

FIG. 11 illustrates the Results screen of FIG. 2, when displaying a folder selection in the information window;

FIG. 12 illustrates a Save As window;

FIG. 13 illustrates a save Cue sheet info window; and

FIG. 14 illustrates a cue sheet information text file.

### DETAILED DESCRIPTION

The following discussion illustrates the structure and operation of an exemplary search tool of the invention. The illustrated search tool is an audio content search tool for searching and previewing audio tracks provided by a content supplier. First, the structure of the search tool is discussed. Next, features from select screens of the search tool are discussed. Finally, an exemplary operation sequence is discussed by reference to a typical user interaction session.

In the illustrated embodiment, the search tool is provided by the content supplier. However, as may be appreciated, the search tool may be provided by third parties not associated with the content, as long as sufficient date regarding the content is available to the third party so as to provide the search terms, as discussed below. The illustrated search tool is preferably generated by the Macromedia Director development tool. However, as may be appreciated, other application development tools are equally effective for generating a search tool in accordance with the invention.

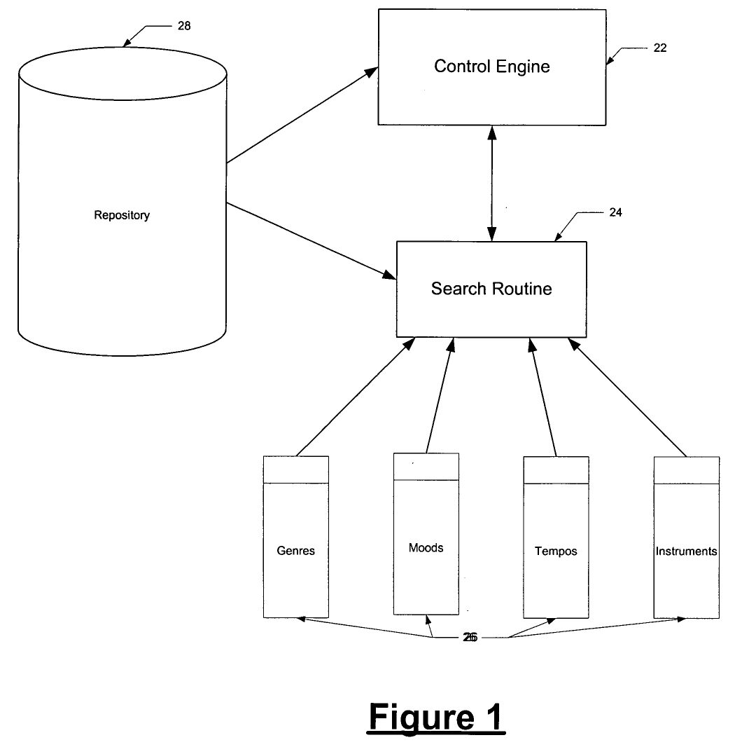

FIG. 1 illustrates a logical arrangement of components which facilitate a search tools of the invention. The components include a main control engine 22, a search routine 24, a plurality of search term files 26, and a content repository 28. The main control engine 22 facilitates the user interaction with the search tool by providing user interaction screens and responding to user commands generated by selecting controls and entering data. The main control engine 22 invokes internal functions to implement user requests. Some of the invoked functions are selecting and reviewing details, replaying, storing a list, exporting a copy of a track, and exporting cue sheet information.

Each of the search term files 26 stores search terms for a particular category associated with the content in the content database. Example search term categories include genres, moods, tempos, and instruments. Each of the search term files 26 preferably includes a plurality of entries, each referring to specific content from the content database and an associated search term. The search terms corresponding to each specific content are presently chosen by an agent of the content provider that reviews the content. Moreover, the possible search terms associated with each category are adopted to provide meaningful and streamlined information relating to the content. In one embodiment, the search terms are part of a standard lexicon created for consumers of the content. Search terms provide a streamlined searching methodology for an organization consuming content. In one embodiment, the search terms are approved by supervisors for use by indexers. Absent such uniform lexicon, each indexer may have its own characterization of content, thus hindering the sharing of content between several consumer users.

The content repository 28 stores data media assets associated with each multimedia content available to the system. In one embodiment, all content data are stored in the same directory location on a storage media. In another embodiment, content data are stored in various directory locations on a single or on a plurality of storage media. In some embodiments, content data are stored by several storage media, including storage media of various types, such as removable, permanent, magnetic, and optical storage.

The search routine 24 receives a search query and executes a corresponding search by reference to data in the search term files 26. The search result provides references to content in the content repository 28. In one embodiment, the references correspond to pointers in a storage table (not shown), which designate the physical storage location of the content data.

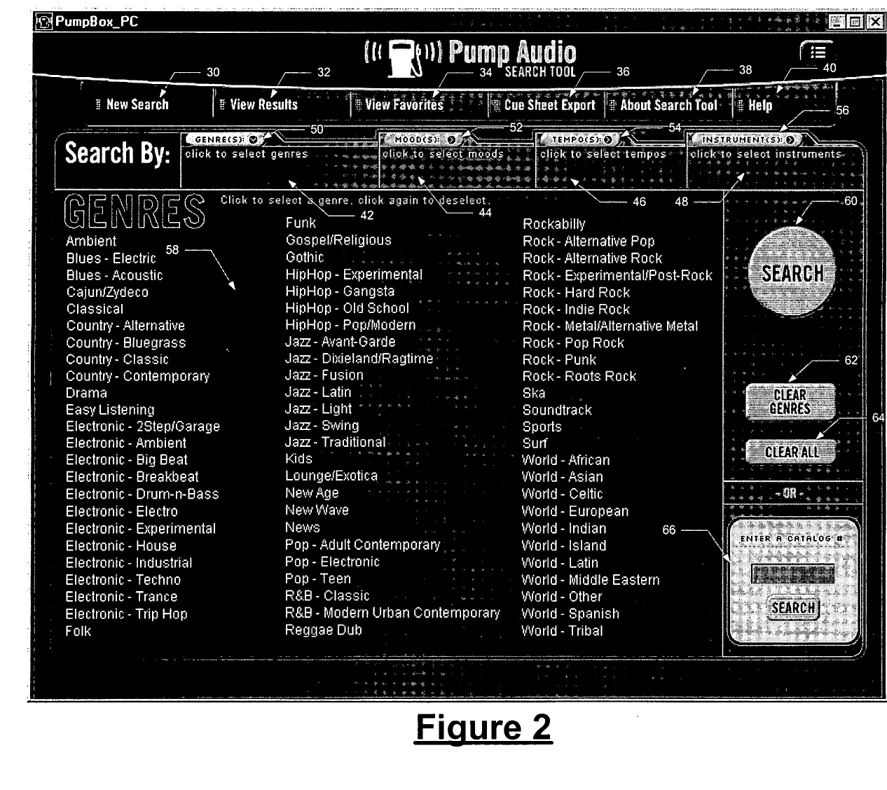

FIG. 2 illustrates a New Search screen of a search tool of the invention. User screens of the exemplary search tool, regardless of associated function, include several common operative and communicative features. These common features include a series of navigation buttons 30, 32, 34, 36, 38, 40, which are provided near the top portion of the screen, arranged across the screen. The navigation buttons include buttons adapted to navigate the search tool to a New Search screen 30, a Results screen 32, a Favorites screen 34, a Cue Sheet Export screen 36, as well as Information 38 and Help 40 screens.

The present discussion does not illustrate the Information 38 and Help 40 screens. However, the structure and operation of such screens will be apparent to one skilled in the art in view of the description herein.

A plurality of search term display boxes 42, 44, 46, 48 are arranged across the screen, below the navigation buttons. The search term boxes include a Genre box 42, a Mood box 44, a Tempo box 46, and an Instrument box 48. Each search term box 42, 44, 46, 48 displays, in the corresponding category, search terms which were selected by the user as part of a current search query. As may be appreciated, in other embodiments of the search tool, where different search term categories are employed, different search term boxes are provided. Furthermore, where the search tool employs additional search term categories, whereby the number of search term boxes would not reasonably fit across the screen, a second level of search boxes, below the illustrated level, is employed.

A search term window 58 is provided by the Search screen, which results from the user selection of the New Search navigation button 30. FIG. 2 illustrates the Search screen after the user has selected a Genre term category by selecting the Genre button 30 adjacent to the Genre term box 42. In this embodiment, the search term window 58 displays the available search terms in the Genre category for content, which is currently available to the search tool. The user selects search terms from the search terms listed in the search term window 58 by clicking one or more terms. The selected terms are added to the user query and are each displayed in a corresponding search term box. In the illustrated screen, when the user selects terms from the search term window 58 displaying Genre terms, the Genre term box 42 displays the selected terms. In one embodiment, the user is allowed to select up to three search terms from each category.

A Search button 60, is provided to facilitate the submission of a search query from the search screen. Once a user has entered all desired search terms, the Search button 60 is selected to indicate that a search query including the selected terms should be submitted to the search routine 24 of the search tool. A Clear Category button, shown as a Clear Genre button 62 in FIG. 2, is provided to clear the selection of terms in the active term category for which terms are displayed in the search term window 58. A Clear All 64 button is provided to facilitate the clearing of all selected search terms, from all categories.

A Search by Catalog number interface 66 includes an entry box for entering catalog number associated with desired content. At times, the user may have available a reference number for content from the content database. This reference number is usually called a catalog number. The catalog number is often assigned to content by the content provider when adding the content to other content generally available to users. In other embodiments, the catalog number is a unique number assigned to the content by a publishing rights group.

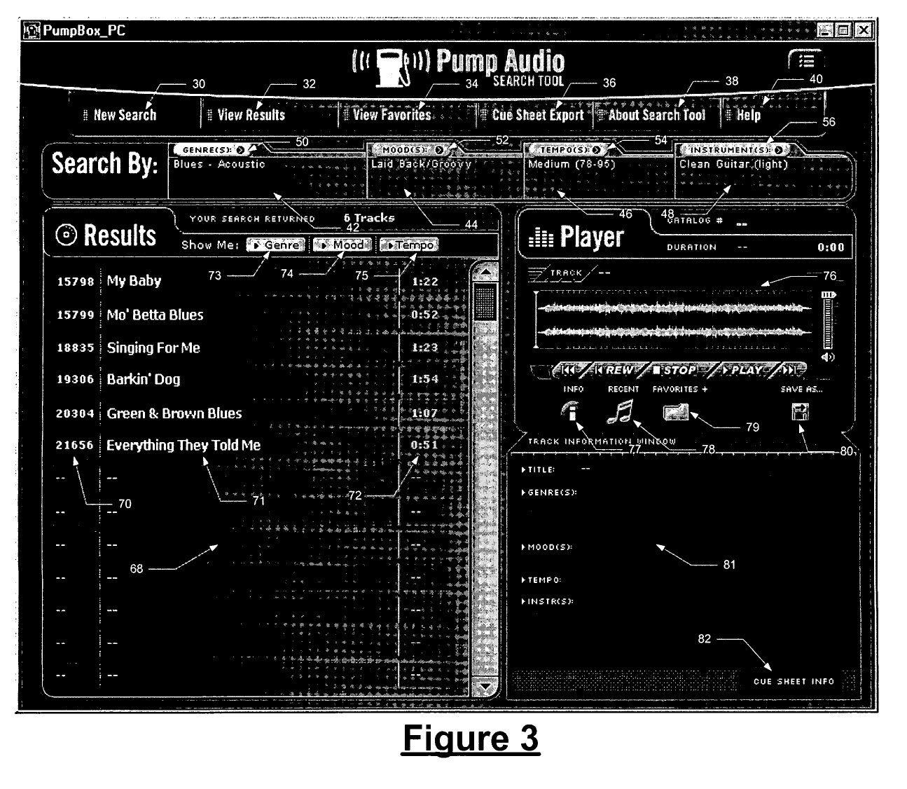

FIG. 3 illustrates a Results screen of the search tool, provided in response to a user selection of the View Results navigation button 32. This screen is provided automatically in response to a selection of the Search button. A Results window 68 provides a listing of content from the database that matches the submitted query, which includes the search terms displayed in the search term boxes 42, 44, 46, 48. An information area of the Results window 68 indicated the number of tracks which comply with the submitted search query. The title 71, catalog number 70, and duration 72 of each track is displayed in the Results window 68.

A set of control buttons 73, 74, 75 allow for controlling the level of detail provided for each listed track. The control buttons 73, 74, 75 preferably include a detail selection button for each term category available to the search tool. The selection of any of the detail selection buttons 73, 74, 75 modifies the track result display to include search term information from the selected category. For example, by selecting the Genre detail button 73, the Genre term associated with each track in the results list is displayed along with the track title 71, catalog number 70, and duration 72, which are already displayed in the compact view.

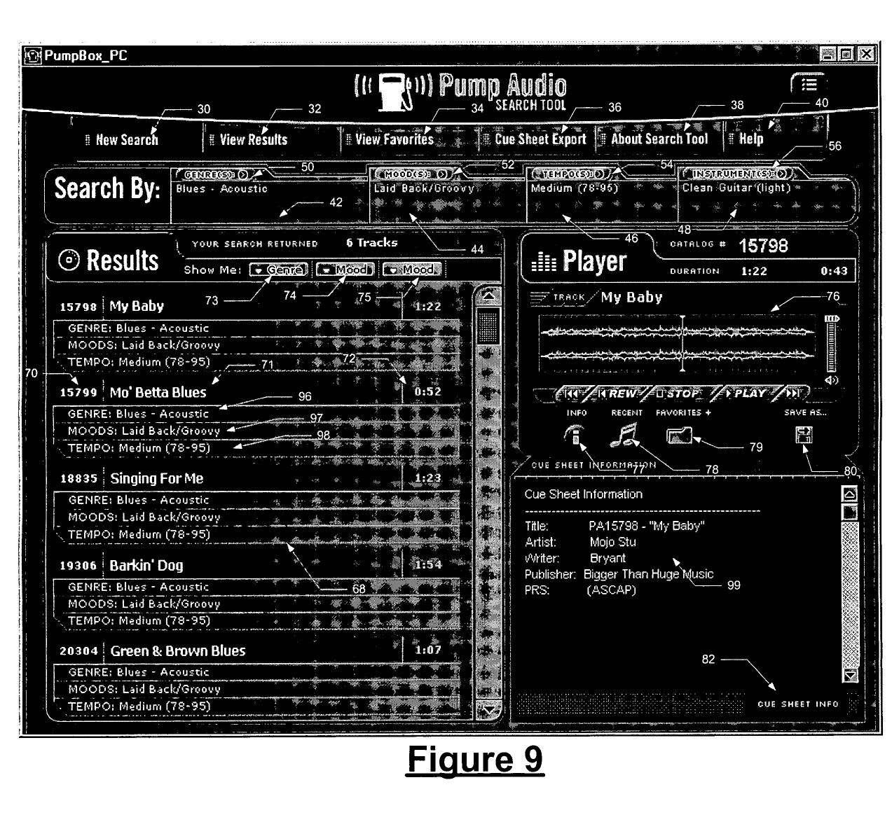

A Player window 76 is provided to facilitate the replaying of selected tracks from the Results window 68. The Player window 76 provides the usual replay controls including next track, previous track, play, stop, and rewind. Such replay controls are known to a person of skill in the art. The Player window further includes an Info button 77, a Recent button 78, an Add to Favorites button 79, and a Save button 80. The Info button 77 is associated with providing additional information regarding the track loaded in the Player window 76. The track information is preferably displayed in a Track Information window 81. The Recent button 78 shows the track titles of all the tracks that were recently reviewed by the user. The Add to Favorites button 79 is associated with adding the track loaded in the Player window 76 to a favorite tracks folder (discussed below). The Save button 80 is associated with storing a copy of the track loaded in the Player window 76 in a directory location, and under a title, as specified by the user. A Track Information window 81 displays information corresponding to the track loaded in the Player window 76. The track information preferably includes search term data associated with the loaded track. The search term data is preferably from each category available to the search tool. A Cue Sheet Information button 82 is provided at the bottom portion of the Track Information window 81 to allow the user to toggle the Track Information window to display Cue sheet Info instead of Track Information, as is illustrated in FIG. 9 (discussed below).

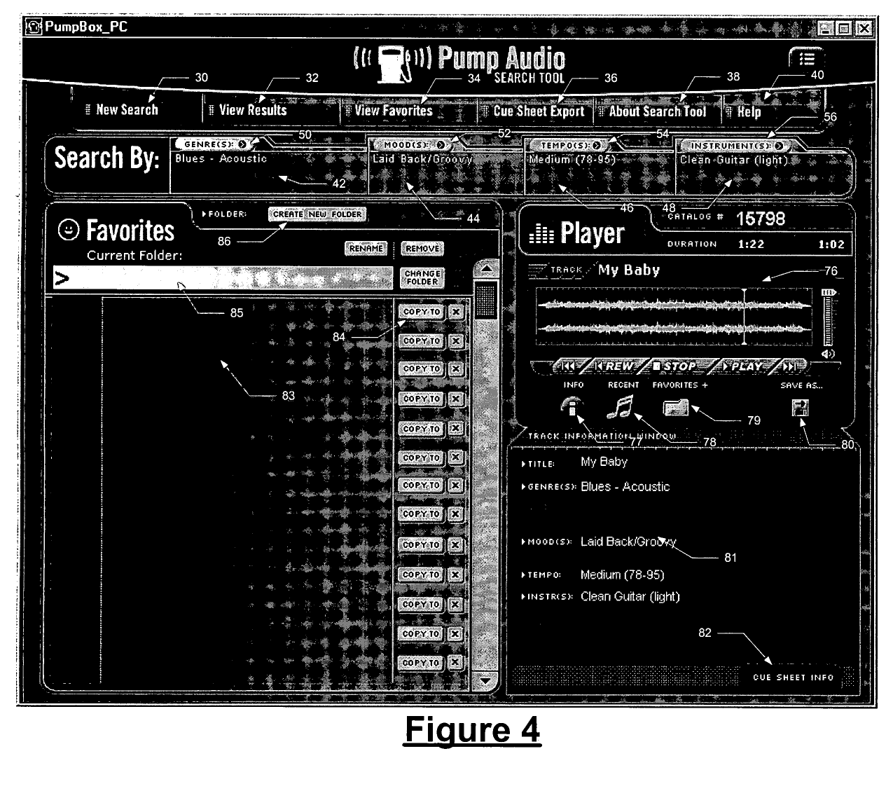

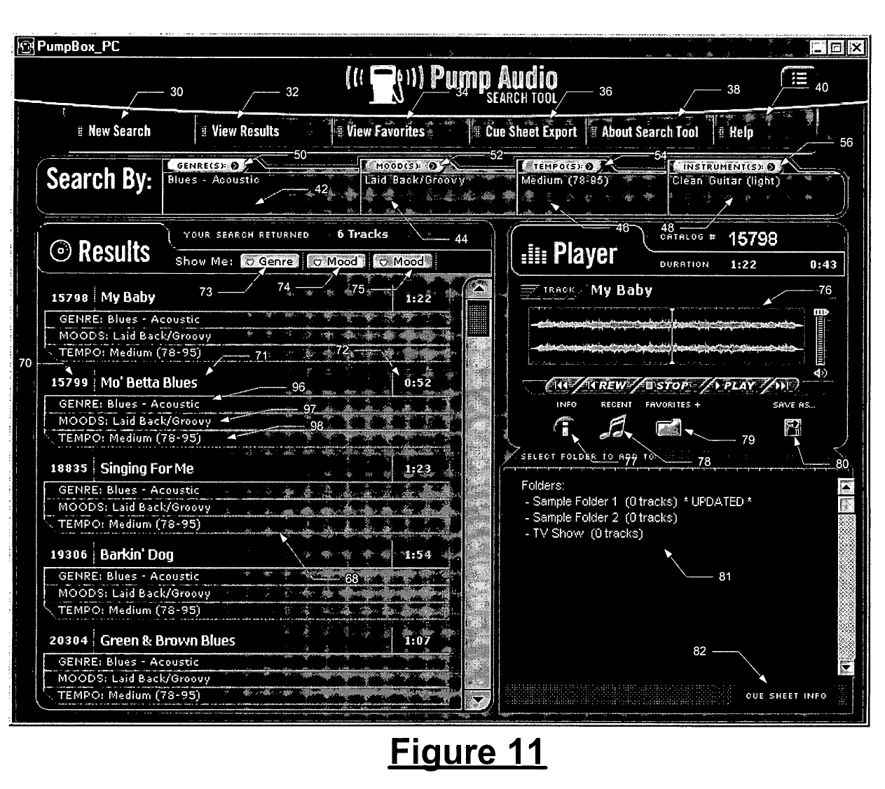

FIG. 4 illustrates the Favorites screen of the search tool, which is provided in response to a user selection of the View Favorites button 34 or the Add to Favorites control 79. The View Favorites button 34 navigates the application to a list of the tracks that have been placed in a favorites folder. The Add to Favorites control 79 allows users to view the favorites folders they have previously created (FIG. 11) By selecting a folder from this view, the user can add the track then playing to the folder.

A Favorites window 83 displays the content of the user selected folder. Specifically, the Favorites window 83 displays the tracks associated with the selected folder. The title and catalog number of each track is preferably displayed as part of the track listing. A Current Folder title box 85 displays the title of the currently selected folder. The Favorites screen also includes a Player window 76 and a Track Information window 81 substantially identical to those provided in the Results screen of FIG. 3.

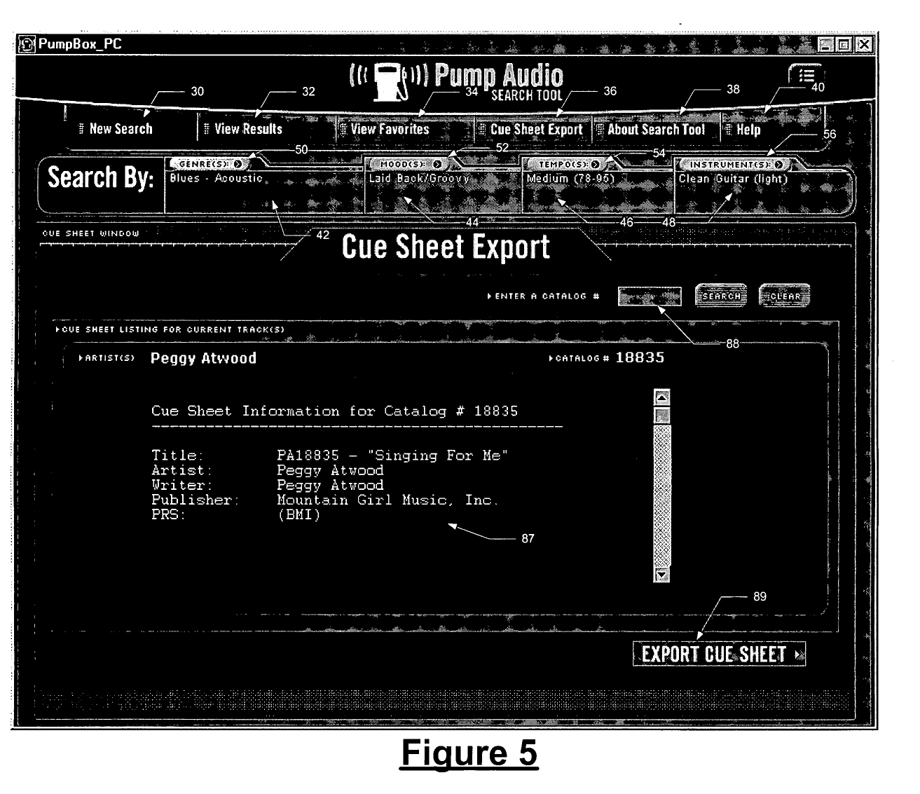

FIG. 5 illustrates a Cue Sheet Export screen of the search tool, which is provided in response to a user selection of the Cue Sheet Export navigation button 36. A Cue Sheet window 87 is provided below the search term boxes. The Cue Sheet window displays cue sheet information for tracks in the current listing, provided by either a favorites folder listing or a results listing, depending on the sequence of operation leading to arriving at the Cue Sheet Export screen. The cue sheet information preferably includes the track title, artist, writer, publisher, and associated Performing Rights Society (PRS), if any. A search box 88 is provided to search for cue sheet information in accordance with a track's catalog number. An Export Cue Sheet button 89 is provided to allow the user to initiate an export of the cue sheet information in the Cue Sheet window to a text file or another form so as to provide a record of the tracks employed by the user. As is known in the art, submission of cue sheet information is required, for example, when employing track content during a radio broadcast or in an advertisement. Generally, any public broadcast on any media requires cue sheets. Such broadcasts included radio, TV-programming, promos, or commercials, as well as Internet use.

The operation of the search tool will now be illustrated by reference to an exemplary interaction between a user and the search tool screens. As may be appreciated, the exemplary interaction is intended to highlight some but not all aspects of the search tool and is not intended to limit the scope of the invention to the discussed features or modes of operation.

In the example interaction, a user is searching for a particular audio track to synchronize with video images that have been filmed for a television production. The user's computer is coupled to a portable content database. One example of such database is the portable storage media discussed in commonly owned co-pending patent application number,* incorporated by reference herein. In one embodiment, the search tool application and associated modules are stored on the same portable media providing the content database. The user launches the search tool application by submitting a corresponding request to the operating system.

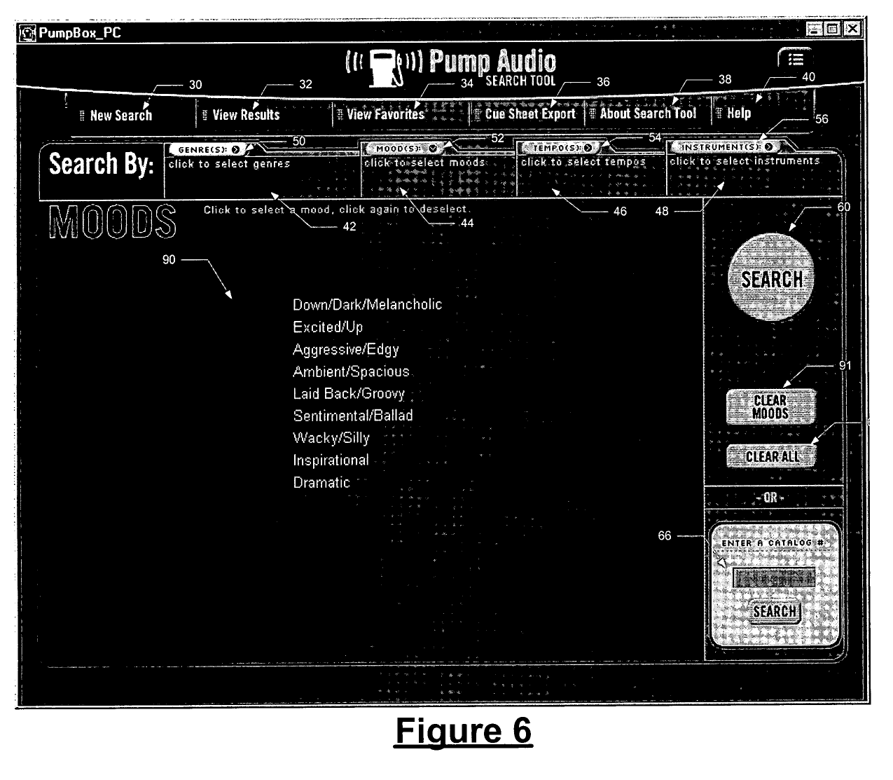

The initial search tool screen provided to the user is the Search screen illustrated in FIG. 2. The Search screen defaults to displaying the first search category in the search term window 58. In the illustrated example interaction, the first category is Genre. Hence, the search tool provides the Genre search terms in the search term window 58. The user decides to search for ACOUSTIC BLUES music. Therefore, the user selects the ACOUSTIC BLUES search term from the search term window 58. Having chosen a genre, the user decides that the search should also indicate a particular mood, which is most appropriate for the production. To display the Mood search terms in the search term window 58, the user selects the Moods control button 52, located at the top of the Moods term box 44. FIG. 6 illustrates the search tool screen presented to the user in response to selecting the Moods control button 52. The user is presented with several Moods category terms 90 to choose from and selects the term LAID BACK/GROOVY.

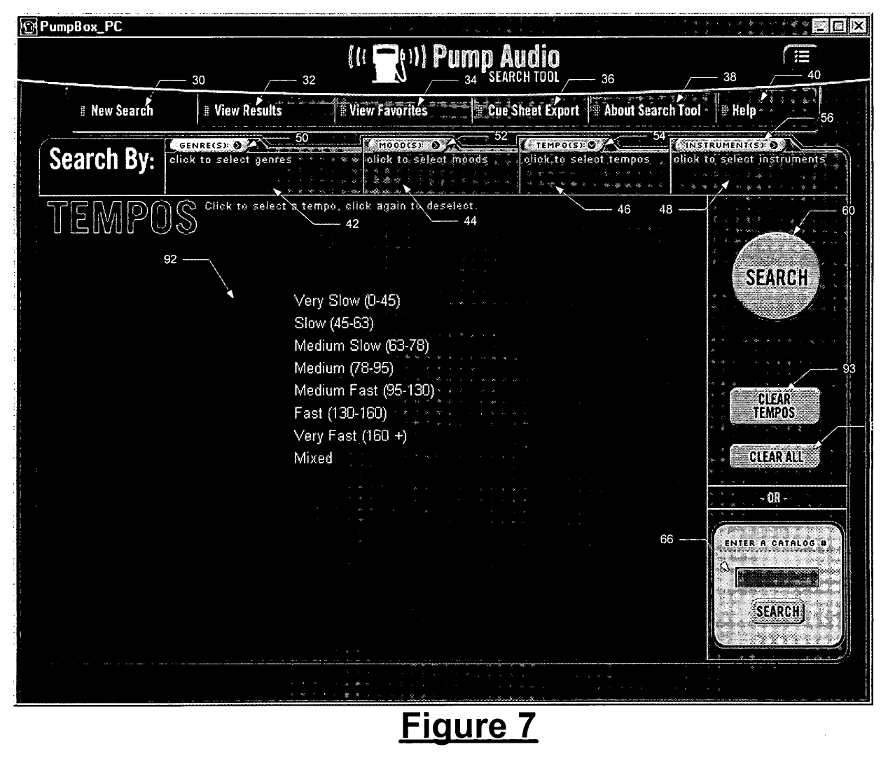

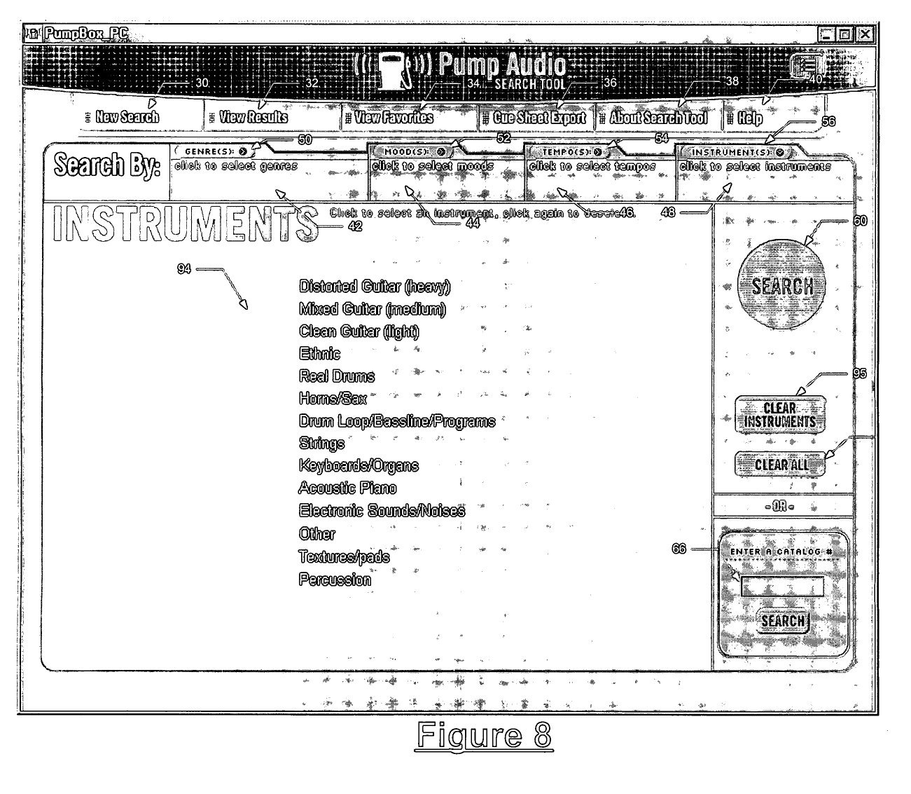

Having selected Genre and Mood terms the user decides that a medium tempo would best suit the LAID BACK/GROOVY, ACOUSTIC BLUES track. The user accordingly selects the Tempo control button 54, located at the top of the Tempo term box 46. The search tool responds to the selection by displaying Tempo category search terms in the search term window 92, as is shown in FIG. 7. The user selects MEDIUM TEMPO from the available search terms 92. Having selected terms from the Genre, Tempo, and Mood categories, the user decides a guitar should be in the track. The user selects the Instrument control button 56, which is located at the top of the Instrument term box 48. The search tool responds to the selection by displaying Instrument category search terms in the search term window 94, as is shown in FIG. 8. The user selects the term CLEAN GUITARS from the displayed Instrument terms window 94.

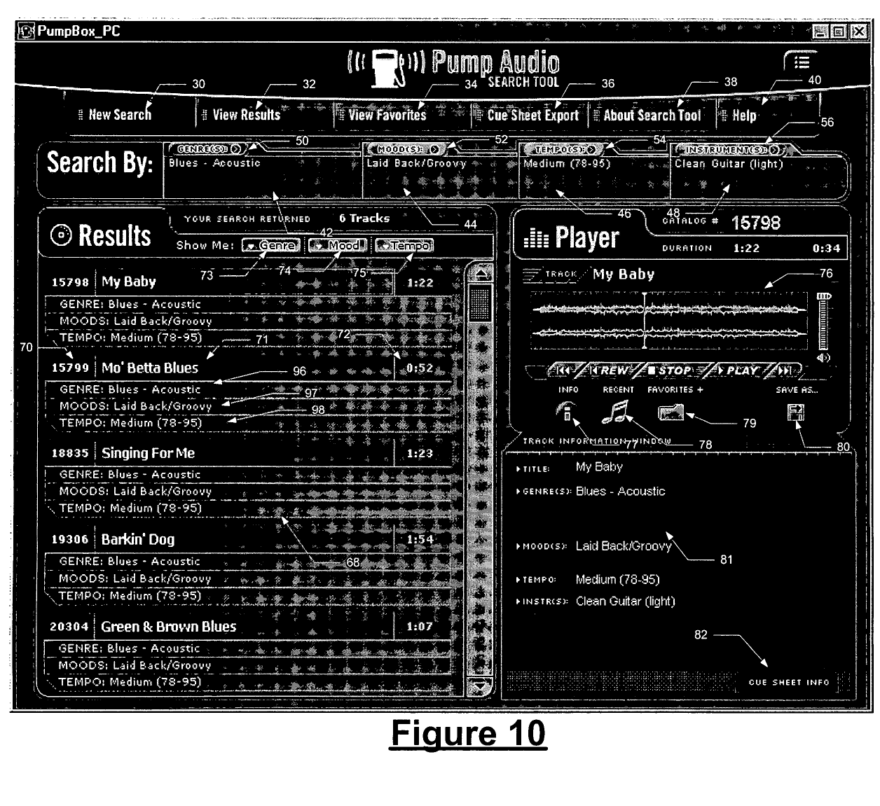

The search tool is now ready to search for content that matches ACOUSTIC BLUES, LAID BACK/GROOVY, MEDIUM TEMPO and CLEAN GUITARS. As may be appreciated, the search term boxes 42, 44, 46, 48 display the selected terms regardless of the search term category or search tool screen presented to the user. The user selects the Search button 60 to execute a search query by the search tool. The search tool responds by displaying the Results screen, which is illustrated in FIG. 3. As may be appreciated, the submitted query provides six matching tracks. Information corresponding to each track is displayed in each row of the Results window 68, as discussed above with respect to FIG. 3. FIG. 10 illustrates the Results window with expanded track detail. FIG. 9 illustrates the Results window with cue sheet information, which is provided in response to selecting the cue sheet information button 82.

After verifying the track detail, the user selects a track to preview by selecting the corresponding title from the Results window 68. The player window 76 loads the track data and starts providing audio to the output device. Additional track data is provided in the Track Information window 81, such as other instruments that are used in the song, and other genres that the song might fall into, as is illustrated in FIG. 10. As may be appreciated, by moving the cursor and selecting the sound wave displayed in the player window 76, the user can alter the replaying to proceed from any portion of the track, as is known in the art.

After listening to the track, the user decides that the track is not quite what they want and therefore previews several other tracks. When the user hears a track that might be appropriate, the user decides to create a favorites folder to collect tracks for the current project. From the screen where the track is selected in the Results window 68, the user selects the Add to Favorites control button 79 to save the track into an unused folder selected from a folder list 81, which is illustrated in FIG. 11. The user selects the View Favorite navigation button to cause the search tool to display the Favorites screen, which is illustrated in FIG. 4. The user then creates a folder with the title of the current project, by selecting the Rename button 21.

The chosen songs are saved in the renamed folder by selecting a track and folder location in the screen of FIG. 4. The user simply selects the Add To Favorites control 79 from the Results screen and then selects the previously created folder they wish to add the song to from the folder window illustrated in FIG. 10. The selected songs can be reviewed at any subsequent time by selecting the View Favorites navigation button 34 and selecting the desired folder. The user can further remove tracks from a favorite folder by selecting the small “x” button adjacent to the track title, as shown in FIG. 4.

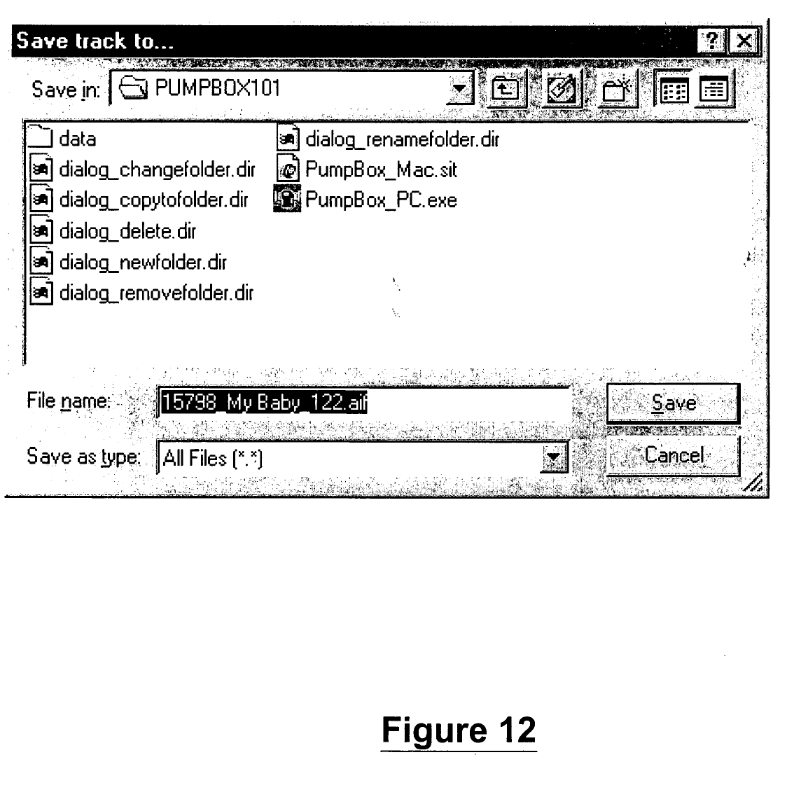

Upon further review with other colleagues, the user decides that one of the tracks placed in the favorites folder will be usable in their production. The user would like to create a copy of the track for export to the video editing equipment, where the music is synchronized with the picture. From the Results screen, the user selects a track so as to load the track onto the Player window 76. The user then selects the Save As control 80 to save a copy of the track to a local drive. The track saving dialog box is illustrated by FIG. 12. The user can now generate a CD copy of the track or internally distribute the track to the video editing unit.

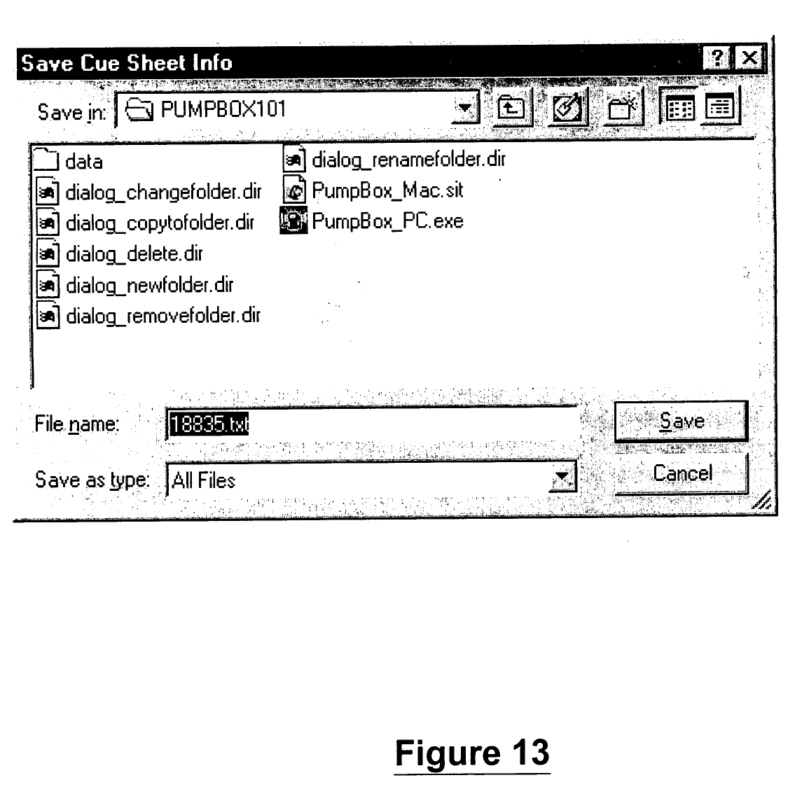

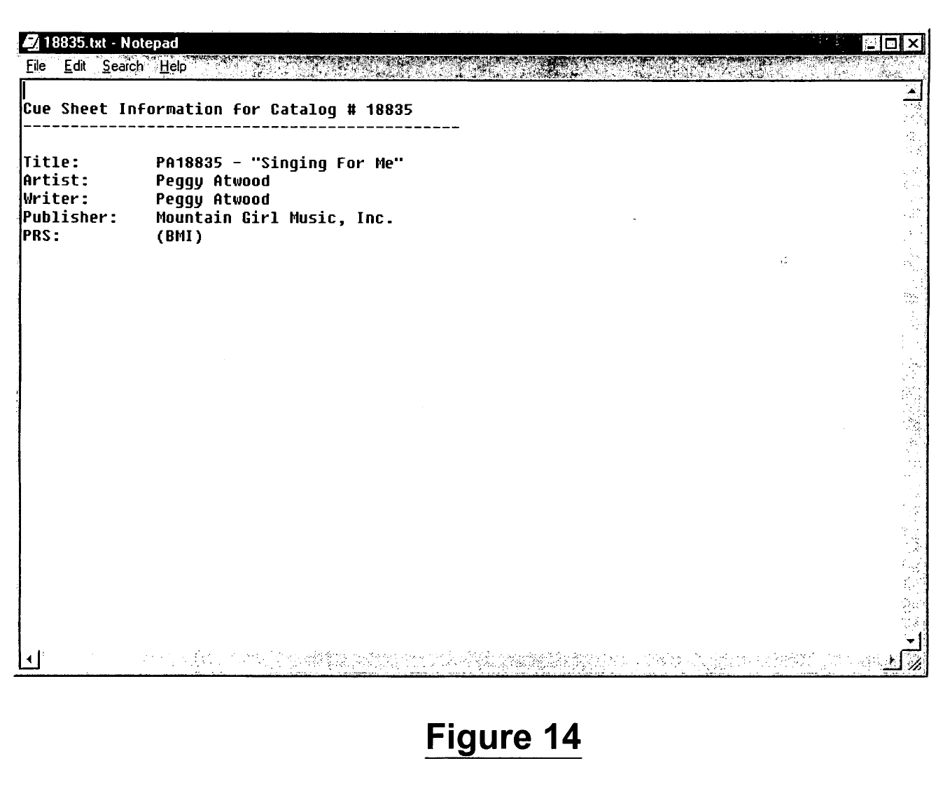

Having added the track into the production, the user is aware of the obligation to create and submit cue sheets to the appropriate performing rights societies. Broadcasters are required to pay dues to the performing rights societies. Those societies monitor all music performances from the cues sheets submitted by the broadcasters and then allocate the dues to the musicians based on the uses. There is a set format to a cue sheet which must be used when submitting the information. Accordingly, the user selects the Cue Sheet Export navigation button 36. The search tool responds to the selection by displaying the Cue Sheet export screen, which is illustrated in FIG. 13. The user selects the Export Cue Sheet control button 89 from the Cue Sheet window 87 to save a copy of the relevant writer and publisher information onto the local drive in text form, which is illustrated in FIG. 14. This information can then be easily compiled into a cue sheet form for submission to the performing rights society.

In other embodiments, the search engine additionally provides a radio player feature (not shown). In one embodiment, this feature allows the user to preview individual tracks either randomly and/or according to genre. The previewing allows the user to become familiar with content without executing specific searches after listening to a track so as to retrieve additional desired tracks. The radio player preferably displays the track identifier, song title, and the search information associated with both the current track and the last track played, when replaying a particular track.

In one embodiment, the system allows the producer to launch a new search for “more tracks like this one” based on the genre, mood, tempo, and other search terms associated with the current track.

An internet link will eventually provide the user with access to technical help, provide the client with the ability to report use of particular content to, and provide the ability to automatically track uses of content.

The foregoing merely illustrates the principles of the present invention. Those skilled in the art will be able to devise various modifications, which although not explicitly described or shown herein, embody the principles of the invention and are thus within its spirit and scope.

1. A method for creating a search query by employing a search tool, comprising:
(a) receiving a user selection of a search category;
(b) retrieving available search terms from a search term file associated with the category;
(c) displaying the available search terms in a user display screen;
(d) providing an interface for selecting search terms from the displayed search terms;
(e) adding the selected terms to a search query; and
(f) submitting the search query to a search engine if the user selects to submit the query or returning to step (b) if the user selects to change search categories.

2. A method for compiling search terms for a search query, comprising:
providing tabs for controlling the selection of categories;
displaying search terms of a selected category;
allowing for the selection of search terms from the displayed search terms;
providing a display box for selected terms of each category;
continuously displaying selected terms from each category in a corresponding display box; and
changing the selection category in response to selection of a category control tab.

3. A method for compiling cue sheet info, comprising:
searching for content;
reviewing content, each content associated with a unique ID;
retrieving cue sheet information from cue sheet database corresponding to the unique ID; and
exporting the cue sheet information as data.

4. The method of claim 3, further comprising adding said content to a favorite folder list, and further wherein said cue sheet information is exported for content in said favorites folder list.

5. A search engine screen, comprising:
a terms display window;
search term boxes, each search term box associated with a search category;
a Search button for facilitating the submission of a search query;
a Clear Genre button for removing search terms of the genre currently associated with the terms display window; and
a Clear All button for removing search terms of any category from a constructed query.

6. A results screen in a search tool, comprising:
a track listing providing at least track title information;
detail level selectors for adjusting the level of track information detail provided in the track listing;
a Player window for replaying audio content data associated with a selected track from the track listing; and
a Track information window for displaying detailed information relating to said audio content data in said player window.
